(19) United States
(12) Patent Application Publication
(10) Pub. No.: US 2010/0295793 A1
(43) Pub. Date: Nov. 25, 2010

(54) Two stroke touch panel data entry system

(76) Inventors: Sudharshan Srinivasan, Fremont, CA (US); Kothandraman Ramchandran, Fremont, CA (US); Jai Kumar, Cupertino, CA (US)

Correspondence Address: SUDHARSHAN SRINIVASAN, 5496 GOLUBIN COMMON, FREMONT, CA, 94555, US

(21) Appl. No.: 12/454,503

(22) Filed: May 19, 2009

(51) Int. Cl. G06F 3/041

(52) U.S. Cl. 345/173

(57) ABSTRACT

A system of data entry on a surface coated with touch sensitive material is provided. This surface is referred herein as touch panel (36). This system is comprised of methods that use touch movement recognition in one of two directions up (44) and down (43) or left (54) and right (53). The touch movements are mapped to a sequential list of basic elements of a language (31). Basic elements can be alphabets (32), numerals (33), ideograms (34) and words (35). Cancellation and selection commands are optionally mapped to left (54) and right movements (53). Selected basic elements are passed onto applications in context of data entry.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to data entry methods and specifically to data entry methods using touch recognition on surfaces with touch sensitive material referred herein as touch panel.

2. Prior Art

Touch panels are surfaces coated with layers of touch sensitive material. These are often used in conjunction with information displays or as alternates to mouse inputs. Touch panels have a capability to detect human touch and transform the touch to analog electronic signals. These analog signals are then converted into digital signals to map the touch into two dimensional coordinates referred herein as touch coordinates. These touch coordinates are then passed to an application that can then respond to a touch at a certain location of the touch panel.

Touch panels are used for data entry into a computing device using several methods.

Touch panels are used as alternatives to a mouse when the touch coordinates are associated with a cursor of a display. This enables movement of a cursor without any restrictions to enable interaction with software programs that are associated with data being displayed in the display. This method of data entry is mostly used for command processing and selection of objects represented as graphical entities in a display.

Touch panels when directly overlaid onto a display eliminate the need of a cursor. This enables data entry into a computing device by touching the touch panel overlaid on the display at appropriate locations without having to move a cursor to a specific location. This method of data entry is also used for command processing and selection of appropriate objects being displayed.

Touch panels when used as display overlays and combined with virtual keyboards that are drawn onto a display also enable data entry such as numbers, alphabets and ideograms of any language. This enables keyboard related data entry using a touch panel without using a separate keyboard.

Touch panels are also used with hand writing recognition software programs such that a user can enter data by writing textual characters onto the touch panel overlaid display and let a hand writing recognition software program translate the touch signals into desired characters.

In all of the above methods of data entry or command entry using a touch panel, a user needs to click on exact coordinates that represent characters or other selectable items.

This is a big limitation if a user needs to enter data using a touch panel that is too small to have sufficient area for each of the characters, or a user is unable to maintain visual contact with the display. This could occur in cases where a user is blind or is not in a position to see the display without losing focus such as when driving, or when trying to type a short message with a mobile phone inside a pocket.

The purpose of this invention is to provide a data entry system for touch panels however small the display size be and also provide for users who are unable to maintain visual contact at all times.

Data entry using a virtual keyboard drawn onto the display is limiting since a user has to touch a precise coordinate representing a character. This may not always be possible when a user does not have visual contact with the display. Even in the case of having visual contact, the virtual key size may be quite small on small displays such as that of mobile phones, creating a problem of multiple key presses instead of just one.

Data entry using hand writing recognition software program is also limiting since hand writing is very user specific and each user has a different style and variation of writing a character. There is no hand writing recognition software program in state of the art that can recognize all variations of characters written with different styluses. This is due to the fact that the combinations of attributes that lead to different styluses can be infinite. Attributes such as height, slant, size, width and other extensions can lead to infinite variations to write a single character. As not all variations can be recognized, probability of errors in hand writing recognition will always be greater than zero implying that a user will need to look at the display to correct any mistakes.

This problem of recognition of infinite variations of characters by hand writing recognition software program was addressed by a solution from a company by name Palm Incorporated. Palm addressed this problem by introducing a method to enter a restricted stroke character set and associated font renditions that are easily recognized by a hand writing software program. This method was called graffiti and was very popular in early days of use. But this method also suffers from some of the problems that are associated with a general purpose character recognition program. For example a number six written using graffiti can be easily mistaken for a letter O. Similarly a letter T written in graffiti can be mistaken for a number one or seven. Hence, although the probability of errors could be reduced, the probability of errors still remained above zero and hence a user is forced to look at the screen and correct any mistakes. This method also forces people to learn a new style of hand writing that can align with the hand writing recognition software program which is not the most desired option.

It can be seen that none of the above mentioned data entry methods using a touch panel display is suitable for a small display such as a mobile phone display or suitable to a user who is unable to maintain visual contact with the display.

Hence there is a need for a touch panel based data entry method that reduces the probability of error of data entry to zero however small the associated display size is.

Following paragraphs in current section describe relevant prior art in this field.

Prior art U.S. Pat. No. 7,015,899 describes a data entry system for small displays, where characters of a language are organized into a two dimensional matrix and a cursor is used to select a particular character. But this does not address the requirement of using touch panel where a finger may overlay multiple characters.

Prior art U.S. Pat. No. 6,882,337 describes a keyboard layout for touch typing with audio cues. This prior art caters to large displays and not small displays. Audio cues are used to aid in figuring out if a touch is in within the bounds of a key or outside. But this does not address the need for a touch pad data entry system associated with small displays such as a mobile phone.

Prior art US patent 20050240879 describes a touch panel data entry where the characters are arranged in a text entry ring. But if the display associated with touch panel is small, the ring can be hard to navigate with a finger that can be quite wide. Hence this is not suitable to address the needs of a small display. This also cannot be used without user looking at the screen.

Another touch panel data entry system is described by google eyesfree project. This particularly addresses the need for data entry without having to maintain visual contact with the touch panel and associated display. But this method uses several strokes to get the appropriate characters in a language. For example numbers are organized at ends of a rectangle and at mid points of a rectangle sides. This gives rise to 8 different strokes. Also English alphabet is partitioned into five groups of letters, and each set is organized as separate rings, and each of these rings are positioned around a bigger circle. Hence to reach a character, a user has to first move in one of five directions, and then use a circular pattern in clock wise or anticlockwise direction resulting in about seven different strokes. In a small display organizing letters in five circles is infeasible and making a user remember which character exists in which circle is impractical. Hence such a system can only be used with larger displays such as those associated with smartphones and not those display that are present in feature phones.

As can be seen from above, all known prior arts suffer from some limitations in offering a solution to data entry using touch panels associated with small displays and when a user is unable to maintain visual contact with the touch panel and associated display.

### OBJECTS AND ADVANTAGES

Accordingly, several objects and advantages of the present invention are:
a) to provide a data entry system for touch panels associated with small displays such as those in mobile phones without the problem of multiple key presses;
b) to provide a data entry system for touch panel associated with displays that do not require a user to maintain visual contact with the display;
c) to provide a data entry system for touch panels that enables precise data entry without associating fixed coordinates between a virtual key and touch panel; and
d) to provide a data entry system for touch panels that enables quick user learning by using only two strokes of lines to get to a character.

### SUMMARY

In accordance with present invention, a data entry system for touch panels is described that is a based on two stroke character navigation method. The two strokes are achieved by using a finger or a stylus on a touch panel in any location and moving the finger in upwards or downwards direction to navigate to a particular character, and then release at a position to make a selection. Optionally a right stroke may also be used to confirm selection and left stroke to reject the selection. Moving down navigates in forward direction in a list of characters, and moving up navigates in backward direction in a list of characters. The two strokes may be vertical or horizontal and is configurable by a user.

Characters are arranged in vertical orientation as a single column from top to bottom or vice versa. Characters may also be arranged in horizontal orientation from left to right or right to left based on user preference. These orientations are further referred to as vertical character list or horizontal character list depending on vertical orientation and horizontal orientation of characters.

This character arrangement is not fixed to any particular coordinate of the touch panel and is not necessarily shown in the touch panel or associated display, hence a user does not have to be in visual contact with the touch panel. A user may touch any part of a touch panel and move up or down to select a character. Navigation between characters can be fast or slow depending on rate of user movement of touch area. If a user moves the finger at a slower rate then the characters navigated to are nearby characters, and if the user moves the finger rapidly, then characters navigated to are distant apart. If the user moves the finger in one of the navigation directions and stops moving without removing the finger from the touch panel, then the navigation could continue to subsequent characters at the previous rate. This enables navigation to characters without moving the finger across the entire touch panel.

Feedback to user about the current position of the finger representing a character is provided either using visual cues and/or audio cues. A visual cue may be provided to a user if the touch panel is associated with a display. A user, who is unable to maintain visual contact with touch panel, or an optionally associated display, will be provided with audio cues representing the current position of navigation.

To reduce the length of the vertical or horizontal character list, the character list may be split up into two columns one for representing a number list and one for alphabet list. Finger pressure and touch area of each finger may also be used to partition a large list. Finger pressure and touch area maybe used to split the character list into a number list and a character list. A finger with larger touch area may represent a character list and another finger with a smaller touch area may be used for a number list.

Since a character is not fixed to any coordinate of touch panel, the problem of multiple key presses will not occur however small the touch panel and associated display is. Since motion recognition is limited to two strokes, the likelihood of errors is reduced to zero as the number of combinations of strokes to recognize is finite and hence easily computable unlike infinite variations of character entry to be processed by the generic hand writing recognition software program.

Providing audio cues in combination with two stroke character navigation method enables use of this data entry method without the need to maintain visual contact with touch panel and associated display.

Hence, using the two strokes character navigation method in combination with audio cues provides an unobvious result of enabling data entry into mobile device touch panels associated with small displays, and also provides an advantage of entering data without maintaining visual contact with touch panel and associated display.

### DRAWINGS—FIGURES

FIG. 1 shows basic elements of a language.

FIG. 2 shows the high level architecture of touch panel data entry system.

FIG. 3 shows typical stroke on touch panel according to this invention.

FIG. 4 shows basic operation of two stroke touch panel data entry system.

FIG. 5 shows two stroke operation with optional select election and cancel strokes.

FIG. 6 shows details of multiple stroke operation for character selection.

FIG. 7 shows multiple regions support.

FIG. 8 show two finger operation.

### DRAWINGS—REFERENCE NUMERALS

31 basic element of language

32 alphabet or character

33 numeral

34 ideogram

35 word

36 Liquid crystal display (LCD) with touch panel

37 LCD driver

38 touch sensor

39 Touch sense processor

40 Application processor

41 speaker

42 vibration transducer

43 down stroke

44 up stroke

45 finger stroke

46 finger touch

47 finger drag

48 finger release

49 drag down

50 drag up

51 element list of alphabets

52 element list of numbers

53 right stroke

54 left stroke

55 Mobile phone touch panel

56 down stroke one

57 down stroke two

58 region one

59 region two

60 Region one up stroke

61 region one down stroke

62 region two down stroke

63 region two up stroke

64 external keypad key

65 Two finger up stroke

66 two finger down stroke

### DETAILED DESCRIPTION OF PREFERRED EMBODIMENT

In the descriptions below, first, basic elements of language are described followed by high level architecture of two stroke character navigation and corresponding data entry are described. Basic elements of a language are arranged into a sequential list with vertical or horizontal orientation. A touch stroke is used to navigate to a basic element of a language. Touch strokes are organized into pairs of stroke directions corresponding to orientations of basic elements. If basic elements are organized into a vertical orientation, then touch strokes are organized into up, down direction movement pair. If basic elements are organized into a horizontal orientation, then touch strokes are organized into left, right direction movement pair.

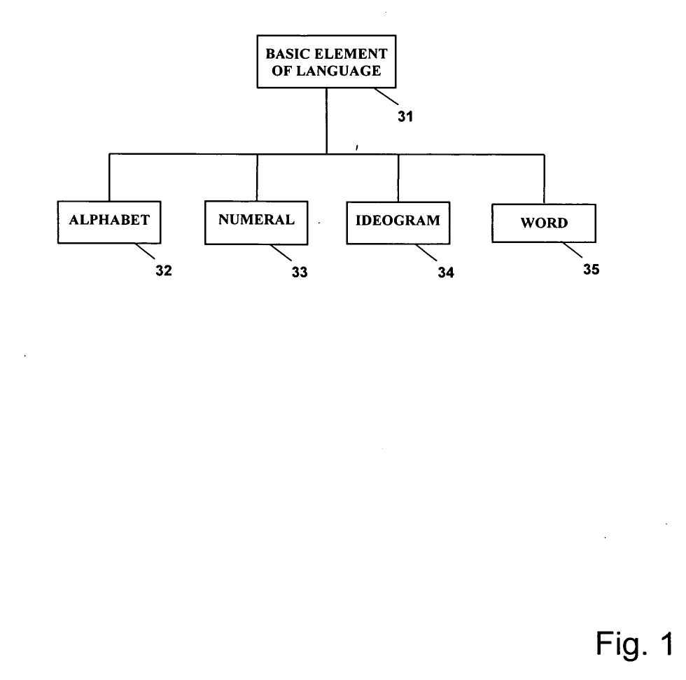

FIG. 1 shows basic element of language 31 that can be one of alphabet or character 32, numeral 33, ideogram 34, and word 35. In further description below, a character is used to represent basic element 31.

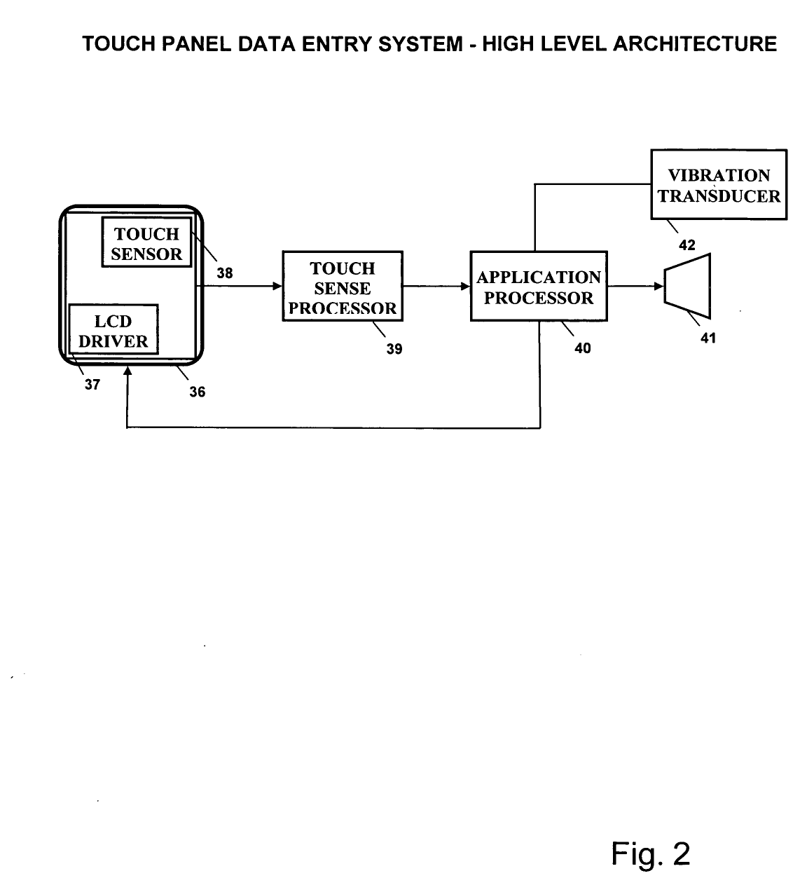

FIG. 2 shows the high level architecture of two stroke touch panel data entry system, the object of present invention. Liquid crystal display (LCD) with touch panel 36 contains LCD driver 37 and touch sensor 38. Finger touches or stylus taps on LCD with touch panel 36 are recognized by touch sensor 38, which converts touches or taps to analog signals. Touch sense processor 39 receives analog signal generated by touch sensor 38 and converts to digital signal representing X for horizontal and Y for vertical coordinates. Application processor 40 receives X and Y coordinates from touch sense processor 39 and based on received X and Y coordinates, generates one of audio, visual and vibration cues to aid two stroke character navigation. The coordinates can represent a single point or area of touch. Audio cue generated by application processor 40 is sent to speaker 41, visual cues are sent to LCD driver 37 to be displayed in LCD with touch panel 36 and vibration cues are sent to vibration transducer 42.

Audio cues are customizable by users. Audio cues can be provided with male or female voice and user recorded voice with customizable pitch, amplitude, language, speed and tempo. Vibration cues can present vibrations with multiple frequencies representing begin, end and mid points of a character set. Touch panel data entry system can be operated using finger touch or stylus tap. In the descriptions below, finger touch method shall represent either form of touch panel data entry operation.

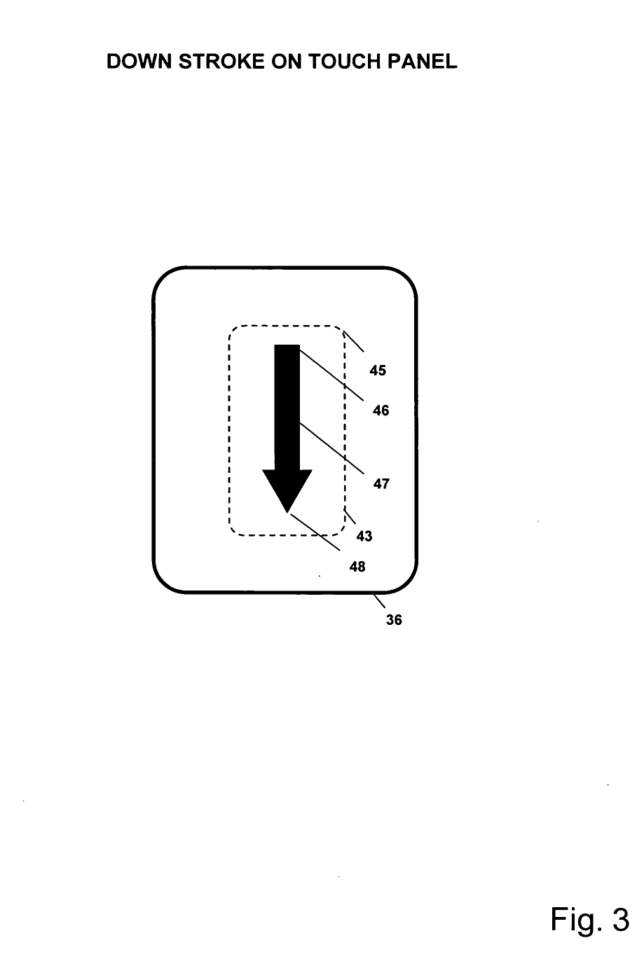

FIG. 3 shows a down stroke 43 on touch panel which is one of the two strokes of present invention. The corresponding stroke to a down stroke is an up stroke 44. A user can configure the two strokes in either vertical or horizontal orientations. If configured for horizontal orientation, the two strokes used would be in leftward and rightward directions. A finger stroke 45 is defined as finger touch 46 which is followed by finger drag 47 and finally by a finger release 48 on LCD touch panel 36. Finger strokes 45 are used for data entry and character navigation. Finger drag 47 can be drag down 49 with corresponding stroke being drag up 50.

The speed of finger drag determines how quickly character navigation is performed. The speed of finger drag enables characters to be skipped to speed up navigation and is user customizable for ease of use. Also according to this invention, touch panel data entry system provides audio, visual and vibration cues during navigation.

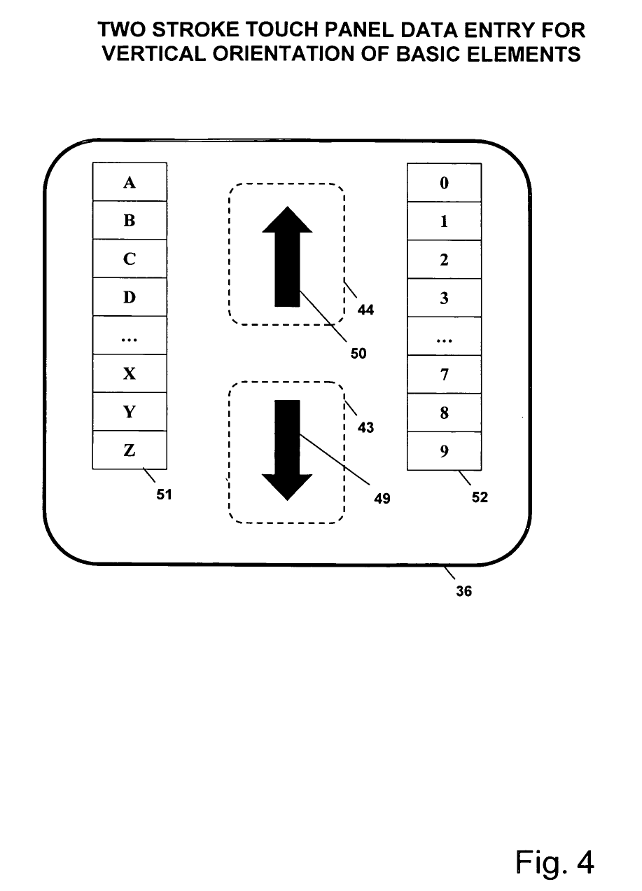

FIG. 4 shows two stroke touch panel data entry system for vertical orientation of basic elements. Up stroke 44 navigates between elements of basic element list in reverse order. As an example, in this figure, basic element list is made up of alphabets in English language and numbers. The element list of alphabets 51 are arranged in sequential order in vertical orientation beginning with alphabet A at the top of the list and ending in alphabet Z at the bottom. The element list of numbers 52 are arranged in sequential order in vertical orientation beginning with number 0 at the top of the list and ending in number 9 at the bottom.

In order to choose a specific alphabet, user begins navigation at any point on the touch panel by touching and dragging a pointing instrument such as a finger in either upward or downward direction until one of an audio, visual, and vibration cue is perceived by the user. As soon as the user perceives one of the above mentioned cues for the desired alphabet, user removes the finger from touch panel indicating a selection. Optionally, a selection may be indicated by a right stroke 53 after perceiving the cue for desired alphabet. If after selection, a user desires to cancel the selection, user touches the screen and moves the finger in the opposite direction to the direction originally used for desired selection within a configurable amount of time referred to as cancellation time. Optionally, a selection may be cancelled by a left stroke 54 within the cancellation time. Navigation between characters may be speeded up using a faster stroke in the desired direction. The screen size determines how far apart the alphabets are placed within an alphabet list which can be configurable based on user preferences.

Multiple lists representing alphabets, words or numerals may be associated with different fingers of a user. Each finger may be identified using area of touch of a finger or pressure used in the touch and corresponding list may be instantiated. The list of words may also be used to implement a menu subsystem of an application that may include keyboard accelerators to instantiate application functionality with fewest character selections needed. Double select on same character is permitted and may initiate keyboard accelerator. For example, character E may be navigated to, and another click at approximately the same location may invoke a keyboard accelerator command. Character E may be mapped to brining up an email application. Such a double select may also be implemented using two right strokes 53, one to select desired character and another to invoke a keyboard accelerator command.

In case of small displays, a single stroke in an upward or downward direction may not be sufficient to represent all characters in a language. In such cases, a user has an option to break the stroke after reaching the boundary of the touch panel in one direction and continuing the stroke from the opposite end within a configurable amount of time to navigate further into the desired list. For example, small display of a low end phone with touch panel may enable representing characters from A to O in vertical orientation. In such a case, if a user wants to navigate to a letter that is beyond O, will first navigate from top to bottom of touch panel using one stroke and will the use a second stroke from the top of the touch panel to navigate to the desired character.

If a user navigates past a desired character, user reverses the direction of motion to get back to the desired character optionally controlling the speed of motion. In addition, autofill capabilities may be implemented using word complete algorithms.

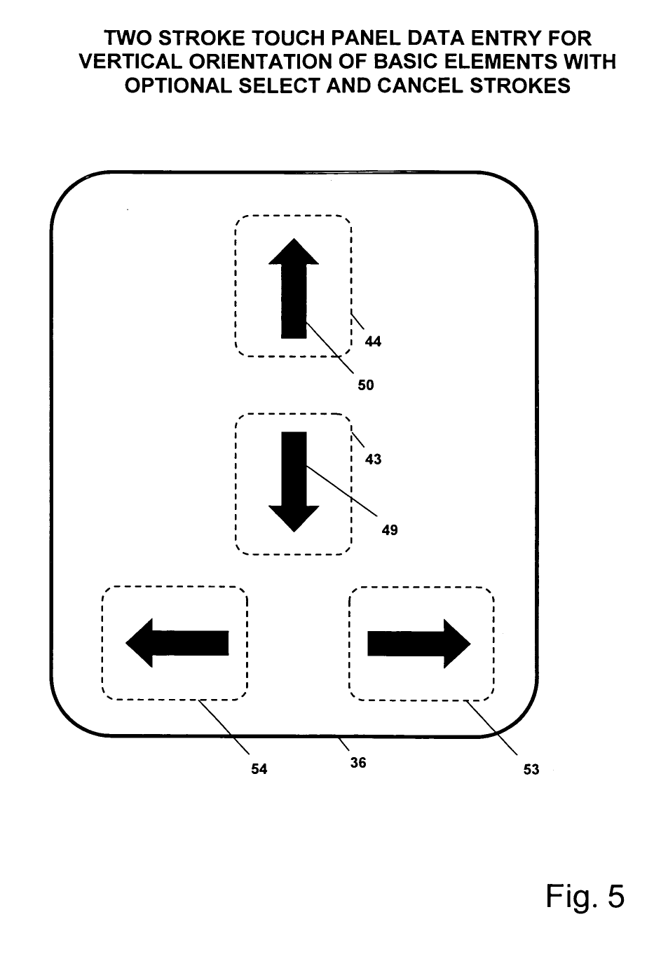

FIG. 5 shows two stroke touch panel data entry system for vertical orientation of basic elements along with optional right stroke 53 for selecting an entry and left stroke 54 for cancelling a selection.

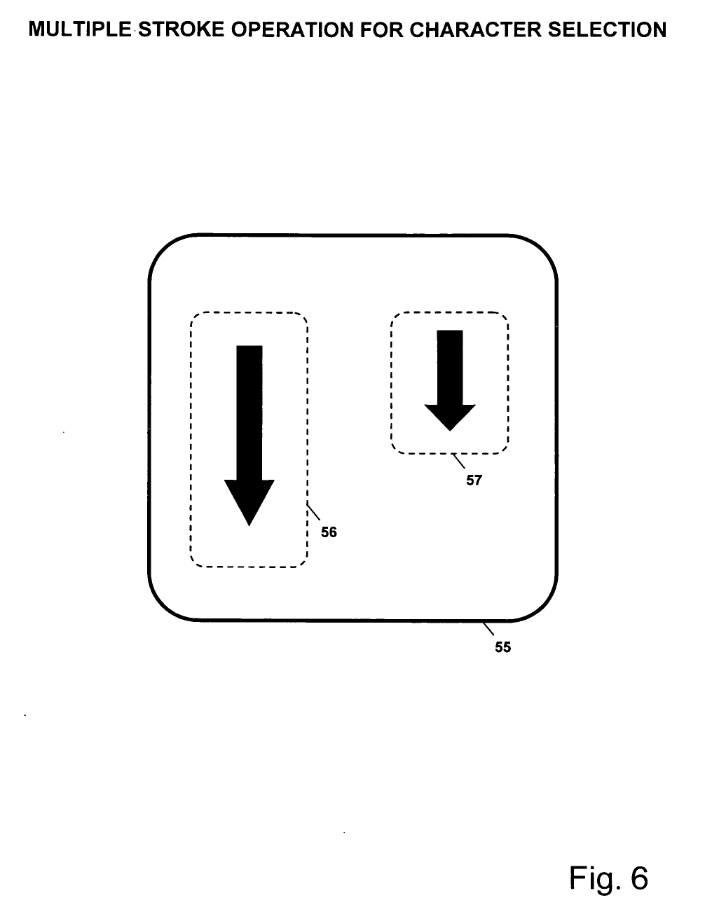

FIG. 6 shows details of multiple stroke operation for character selection. In one of the embodiment of this invention, touch panel data entry system is used in a mobile phone environment. Mobile phone touch panel 55 is typically small and may not have sufficient length to support touch panel data entry character navigation when there are numerous characters involved, say for example English language alphabet. Mobile phone touch panel 55 length limitation can be overcome by supporting multiple strokes to navigate large character set. If user is trying to enter character M and starts off by initiating down stroke one 56, touch panel data entry system is able to navigate up to say character K at the completion of down stroke one 56. In order to enter character M, user starts another stroke within a time period by initiating down stroke two 57, indicating the continuation of character entry operation. During execution of down stroke two 57, touch panel data entry system starts navigating from character L and hence user is able to reach character M to complete character entry.

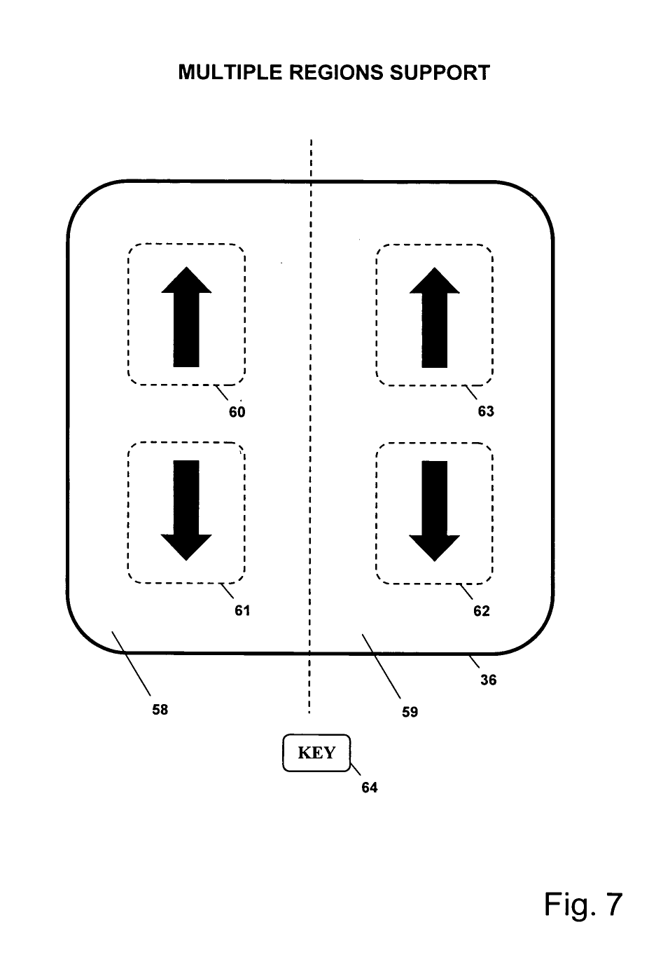

FIG. 7 shows multiple regions support. In one embodiment of this invention, multiple regions are supported to enable touch panel data entry. LCD with touch panel 36 is divided into region one 58 and region two 59. Region one 58 may be assigned to English alphabet character set whereas region two 59 may be assigned to numerals. Region one up stroke 60 and region one down stroke 61 are used to enter English alphabet character where as region two down stroke 62 and region two up stroke 63 are used to enter numerals. Assignment of region one 58 and region two 59 may fixed or can be changed dynamically by using an external keypad key 64 by the user.

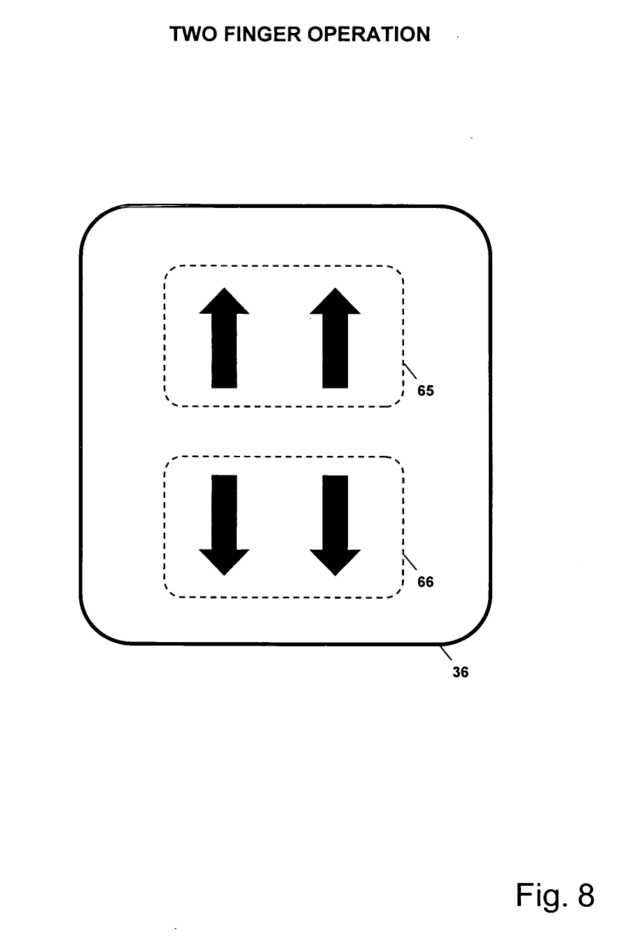

FIG. 8 shows two finger operation. Two finger up stroke 65 and two finger down stroke 66 operation can also be supported for data entry along with down stroke 43 and up stroke 44 using one finger. Two finger operation may be used to enter numerals whereas one finger operation may be used for entering characters. This provides additional convenience to users while entering characters and numbers during data entry.

### ADVANTAGES

From the description above a number of advantages of this wireless system become evident:
a) a data entry system for touch panel based displays is provided that does not require a user to maintain visual contact with the display;
b) a data entry system for touch panels is provided that enables precise data entry without associating fixed coordinates between a virtual key and touch panel;
c) a data entry system for touch panels is provided that enables quick user learning by using only two strokes of lines to get to a character; and
d) a data entry system for touch panels is provided in portable devices such as mobile phones that enables use of small screen display associated touch panels to enter data without the problem of multiple key presses.

### CONCLUSIONS, RAMIFICATIONS AND SCOPE

Accordingly, the reader will see that the data entry system of present invention providing a two stroke character navigation and data entry method, will enable data entry into touch panels associated with small displays without the necessity of maintaining visual contact.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A data entry method for a surface coated with touch sensitive material herein referred to as touch panel comprising:
a) arranging basic elements of any language in a sequential list with orientation selected from group consisting of vertical orientation, and horizontal orientation;
b) associating said list with said touch panel;
c) associating a pair of directions of touch movement further referred to as navigation directions, of a pointing instrument of a user with corresponding two commands selected from group consisting of navigate backward to said basic element command, and navigate forward to said basic element command, wherein said pair of directions is selected from group consisting of up, down movement direction pair, and left, right movement direction pair wherein said commands are further referred to as navigation commands;
d) bringing into contact said pointing instrument with said touch panel to begin said navigation;
e) moving said pointing instrument in either direction in said pair of directions to navigate to said desired basic element; and
f) releasing said contact at a certain point in said touch panel to confirm selection of said basic element.

2. The method of data entry of claim 1, further comprising:
a) associating directions orthogonal to said navigation directions, further referred to as selection directions, with corresponding two commands selected from group consisting of select basic element command, and cancel selection of basic element command, wherein said commands are further referred to as selection commands.

3. The method of data entry of claim 1, further comprising:
a) associating plurality of consecutive movements in one of said directions with commands other than said navigation and selection commands.

4. The method of data entry of claim 1, wherein said basic element is selected from group consisting of alphabet, numeral, ideogram, and word.

5. The method of data entry of claim 1, further comprising:
a) associating rate of said touch movement with rate of navigation between said basic elements in said list.

6. The method of data entry of claim 1, wherein said pointing instrument is selected from group consisting of a finger of said user, and a stylus.

7. The method of data entry of claim 6, further comprising:
a) identifying said finger of said user based on finger metrics selected from group consisting of area of said touch, and pressure of said touch area of said touch on said touch panel; and
b) associating said identified finger with subset of said basic elements chosen from said list.

8. The method of data entry of claim 1, further comprising:
a) associating said navigation and select commands with feedback cues to said user wherein said feedback cue is selected from group consisting of audio feedback cue, visual feedback cue and vibration feedback cue.

9. The method of data entry of claim 1, further comprising:
a) partitioning said touch panel into plurality of areas; and
b) associating said area with subset of said basic elements from said list.

10. The method of data entry of claim 1, further comprising:
a) associating hardware buttons outside of said touch panel to activate entry of said basic elements.

11. A device for data entry of basic elements of a language comprising:
a) a surface coated with touch sensitive material herein referred to as touch panel;
b) a software program to recognize a pair of directions of movements further referred to as navigation directions, by a user of a pointing instrument coupled to said touch panel, said pair of directions selected from group consisting of up, down movement direction pair and left, right movement direction pair;
c) said software program further comprising association logic to associate said directions of movements with corresponding commands selected from group consisting of navigate backward to said basic element command, and navigate forward to said basic element command said commands further referred to as navigation commands.

12. The device of data entry of claim 11, further comprising:
a) a software program to recognize a pair of directions orthogonal to said navigation directions, further referred to as selection directions, with corresponding two commands selected from group consisting of select basic element command, and cancel selection of basic element command, wherein said commands are further referred to as selection commands.

13. The device for data entry of claim 11, wherein said basic element is selected from group consisting of alphabet, numeral, ideogram, and word.

14. The device for data entry of claim 11, further comprising:
a) a software program that associates plurality of consecutive said movements in one of said directions with commands other than said navigate and select commands.

15. The device for data entry of claim 11, further comprising:
a) a software program that associates rate of said touch movement with rate of navigation between said basic elements in said list.

16. The device for data entry of claim 11, wherein said pointing instrument is selected from group consisting of a finger of said user, and a stylus.

17. The device for data entry of claim 16, further comprising:
a) a software program that identifies said finger of said user based on finger metrics selected from group consisting of area of said touch, and pressure of said touch on said touch panel; and
b) a software program that associates said identified finger with subset of said basic elements chosen from said list.

18. The device for data entry of claim 11, further comprising:
a) a software program that associates said navigation and select commands with feedback cues to said user wherein said feedback cue is selected from group consisting of audio feedback cue, visual feedback cue and vibration feedback cue.

19. The device for data entry of claim 11, further comprising:
a) plurality of areas partitioned in said touch panel; and
b) a software program that associates said area with subset of said basic elements.

20. The device for data entry of claim 11, further comprising:
a) a software program that associates hardware buttons outside of said touch panel to activate entry of said basic elements.
